(19) United States
(12) Patent Application Publication
(10) Pub. No.: US 2016/0353711 A1
(43) Pub. Date: Dec. 8, 2016

(54) EXPANDABLE PET TUNNEL DEVICE

(71) Applicant: PAMPERED PET PARTIES, LLC, Marietta, GA (US)

(72) Inventors: LYNN BAHR, MARIETTA, GA (US); CANDICE SIDES, WOODSTOCK, GA (US)

(21) Appl. No.: 15/176,976

(22) Filed: Jun. 8, 2016

Related U.S. Application Data
(60) Provisional application No. 62/172,328, filed on Jun. 8, 2015.

(51) Int. Cl. A01K 15/02

(52) U.S. Cl. CPC A01K 15/025

(57) ABSTRACT

Various embodiments, aspects and features of the present invention encompass an expandable pet tunnel. It is envisioned that embodiments of the solution for an expandable pet tunnel may be constructed from any material suitable for a given application, although a preferred embodiment may be constructed from kraft paper. An exemplary embodiment may be constructed of a relatively thick paper and reside in either a collapsed state or an expanded state. When in the collapsed state, the exemplary embodiment may take the shape of a square. When in the expanded state, the exemplary embodiment may take the shape of a rectangular tube or tunnel that is open at either or both of its ends. When transitioning from the collapsed state to the expanded state, the exemplary embodiment may expand “accordion-like” according to a series of gussets or folds in the side walls of the embodiment.

### CROSS-REFERENCE TO RELATED APPLICATIONS

This application claims priority under 35 U.S.C. §119(e) to U.S. provisional application entitled “EXPANDABLE PET TUNNEL DEVICE,” filed on Jun. 8, 2015 and assigned application Ser. No. 62/172,328, the entire contents of which are hereby incorporated by reference.

### BACKGROUND

The present invention relates to toys and products for pets and, more particularly, to an expandable pet tunnel device constructed from durable “kraft” paper such as may be used in traditional paper grocery bags. Pet tunnel devices known in the art are commonly marketed for use by various types of pets including, but not limited to, cats, ferrets, mice, small dogs, etc. As pet owners know all too well, pets can be destructive users of toys and devices, and their use of pet tunnel devices is no less destructive.

For example, pet tunnels known in the art can be expensive devices in the form of fabric “tubes” or open ended box-like structures that pets eagerly run through and hide in. Naturally, through such normal use, sharp claws and excited fits of chewing can quickly destroy a pet tunnel, leaving the pet owner with a choice between replacing the expensive device or depriving her beloved pet from the joy of having its own tunnel.

Therefore, what is needed in the art is a pet tunnel device that is inexpensive to manufacture and to replace. Moreover, what is needed in the art is an expandable pet tunnel device configured for construction from a durable, yet recyclable, material such as kraft paper.

### BRIEF SUMMARY OF THE INVENTION

Various embodiments, aspects and features of the present invention encompass an expandable pet tunnel. It is envisioned that the solution may be constructed according to any given size suitable for use by a given animal. That is, it is envisioned that the solution is not limited by size and that certain embodiments may be sized appropriately for animals ranging in size from a mouse or gerbil to a large dog. Also, it is envisioned that embodiments of the solution for an expandable pet tunnel may be constructed from any material suitable for a given application, although a preferred embodiment may be constructed from kraft paper such as that which is well known for use in paper grocery bags. The optimum basis weight of the kraft paper used for a given embodiment will occur to those of skill in the art, the basis weight being the thickness of the kraft paper. As one of ordinary skill in the art of paper understands, as the measure of basis weight climbs in number, so grows the thickness of the paper with which it is associated. For example, paper with a basis weight of 30 lbs. to 49 lbs. may be marked as “standard duty,” while paper associated with a basis weight of 50 lbs. and up may be marked as “heavy duty.”

An exemplary embodiment of the solution is sized ideally for a cat or small dog, such as a dachshund. The exemplary embodiment may be constructed of a relatively thick paper and reside in either a collapsed state or an expanded state. When in the collapsed state, the exemplary embodiment may take the shape of a square. When in the expanded state, the exemplary embodiment may take the shape of a rectangular tube or tunnel that is open at either or both of its ends. When transitioning from the collapsed state to the expanded state, the exemplary embodiment may expand “accordion-like” according to a series of gussets or folds in the side walls of the embodiment.

Advantageously, because an embodiment of the solution may be expanded from a collapsed state to an expanded state, an unused pet tunnel according to the novel solution may be conveniently stored in the collapsed state and then expanded only when called into duty for the benefit of the pet. As a further advantage, because the exemplary embodiment is constructed of paper, it may be discarded or recycled when its usefulness has waned due to wear and tear from a loving pet.

Embodiments of an expandable pet tunnel according to the solution are not limited to the exemplary aspects and features described above or below. Certain embodiments may include additional features, or different features, while other embodiments include alternative features.

### BRIEF DESCRIPTION OF THE DRAWINGS

In the drawings, like reference numerals refer to like parts throughout the various views unless otherwise indicated. For reference numerals with letter character designations such as “102A” or “102B”, the letter character designations may differentiate two like parts or elements present in the same figure or different figures. Letter character designations for reference numerals may be omitted when it is intended that a reference numeral encompass all parts having the same reference numeral in all figures.

FIG. 1 is a front perspective view of an exemplary embodiment of an expandable pet tunnel according to the solution, shown in a collapsed state;

FIG. 2 is a front perspective view of the exemplary embodiment of an expandable pet tunnel in FIG. 1, shown in a partially expanded state;

FIG. 3 is a front perspective view of the exemplary embodiment of an expandable pet tunnel in FIG. 1, shown in a fully expanded state;

FIG. 4A is a front-view of the exemplary embodiment of an expandable pet tunnel in FIG. 1, shown in a collapsed state;

FIG. 4B is a front view of the exemplary embodiment of an expandable pet tunnel in FIG. 1, shown with an outer front face element folded back to expose an interior reinforcement feature;

FIG. 5 is a side view of the exemplary embodiment of an expandable pet tunnel in FIG. 1, shown in a collapsed state;

FIG. 6 is a top view of the exemplary embodiment of an expandable pet tunnel in FIG. 1, shown in a collapsed state;

FIG. 7 is a top view of the exemplary embodiment of an expandable pet tunnel in FIG. 1, shown in a fully expanded state;

FIG. 8 is a side view of the exemplary embodiment of an expandable pet tunnel in FIG. 1, shown in a fully expanded state;

FIG. 9 is a front perspective view of an exemplary embodiment of an expandable pet tunnel according to the solution, shown in a collapsed state;

FIG. 10 is a front perspective view of the exemplary embodiment of an expandable pet tunnel in FIG. 9, shown in a partially expanded state;

FIG. 11 is a front perspective view of the exemplary embodiment of an expandable pet tunnel in FIG. 9, shown in a fully expanded state;

FIG. 12 is a front perspective view of an exemplary embodiment of an expandable pet tunnel according to the solution, shown in a collapsed state;

FIG. 13 is a front perspective view of the exemplary embodiment of an expandable pet tunnel in FIG. 12, shown in a partially expanded state; and

FIG. 14 is a front perspective view of the exemplary embodiment of an expandable pet tunnel in FIG. 12, shown in a fully expanded state.

### DESCRIPTION

The Figures and the related description are offered for illustrative purposes and depict exemplary embodiments of an expandable pet tunnel device according to the solution. As such, the exemplary embodiments shown in the Figures do not necessarily illustrate all features and aspects that may be included in a given embodiment of an expandable pet tunnel device according to the solution. For instance, it is envisioned that an expandable pet tunnel device according to the solution may be manufactured to any given size suitable for a particular pet and/or may be constructed from any combination of materials depending on the intended use of the particular embodiment. Moreover, although the exemplary embodiment shown in the Figures is constructed based on a tube with a square cross-section, it is envisioned that other embodiments may be constructed based on a tube with a round cross-section or a multi-walled cross-section. Further, although the exemplary embodiments shown in the Figures feature only a pair of entry/exit portals at their ends, it is envisioned that certain embodiments may feature entry/exit portals at one or more locations on the side walls in addition to, or in lieu of, the entry/exit portals located on the ends. Moreover, it is envisioned that multiple expandable pet tunnels may be arranged into a system of tunnels by juxtaposing an entry/exit portal of one expandable pet tunnel with an entry/exit portal of another expandable pet tunnel. Even further, it is envisioned that the outer surfaces and/or sides of certain embodiments of an expandable pet tunnel may feature an adhesive or some other means of attachment for facilitating the juxtaposition of two or more expandable pet tunnels into a system.

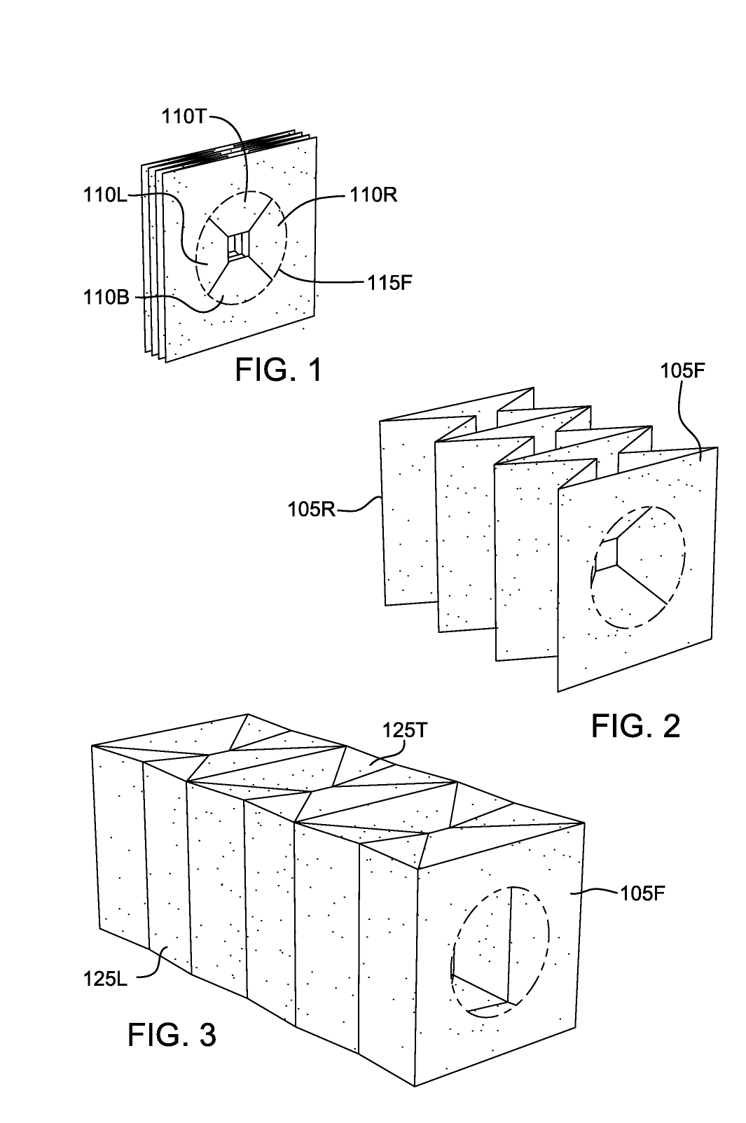

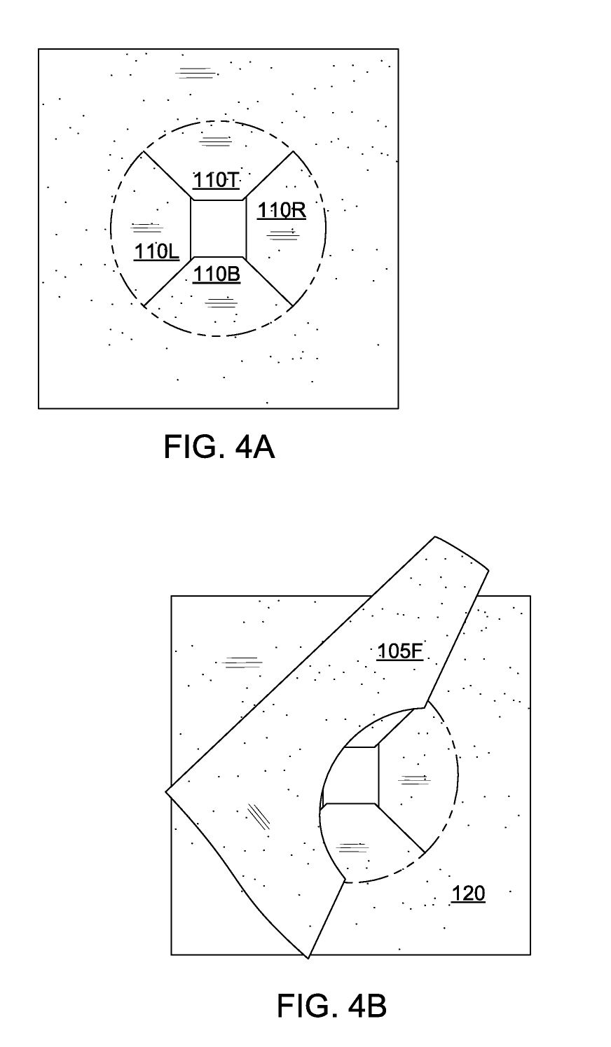

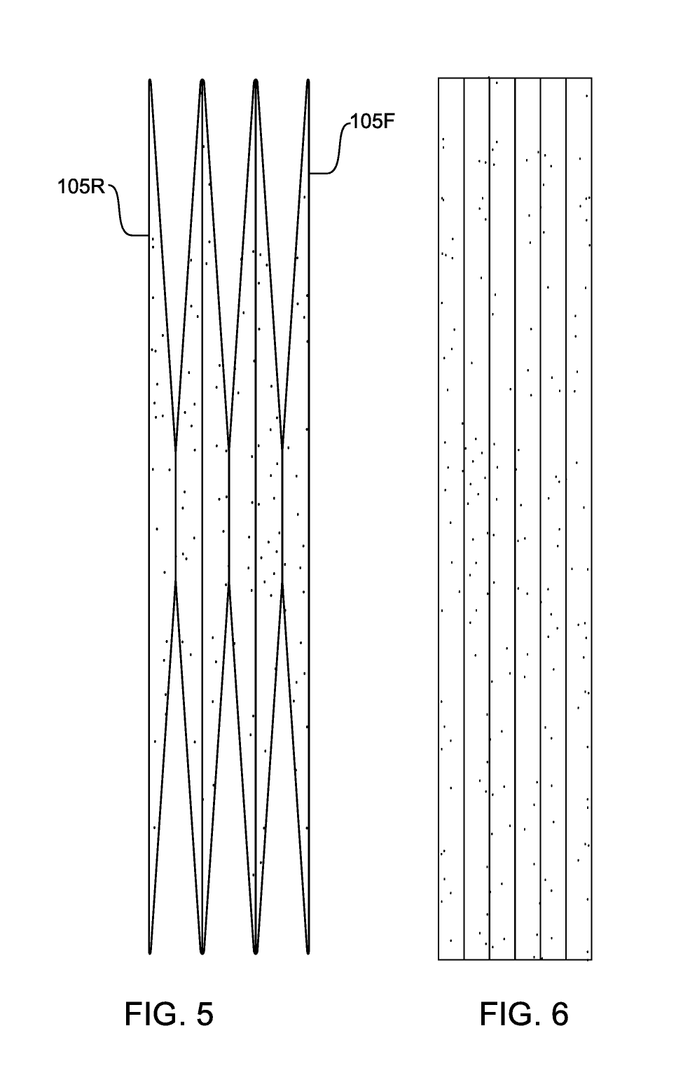

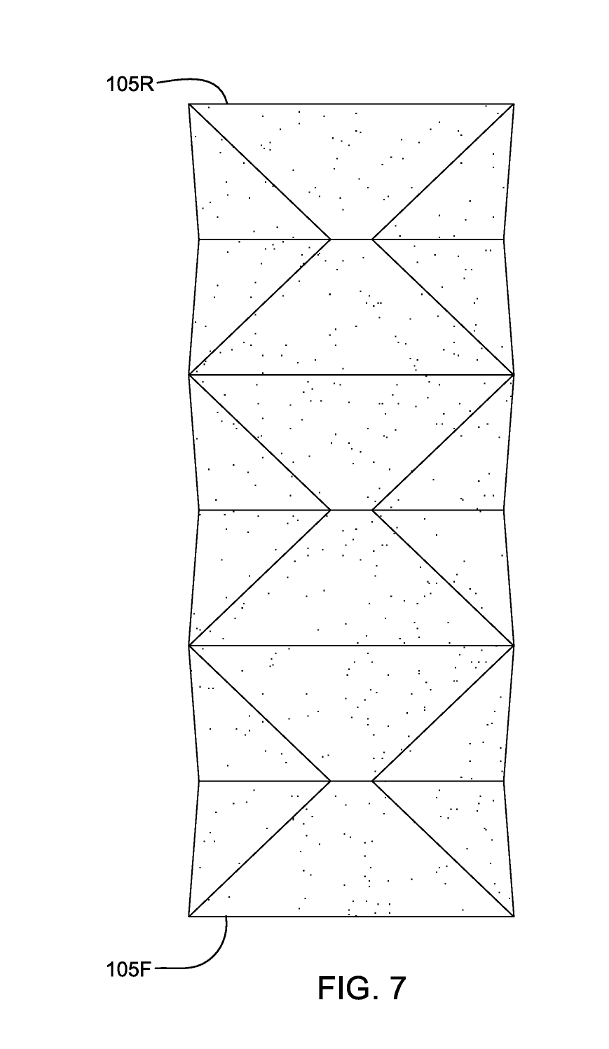

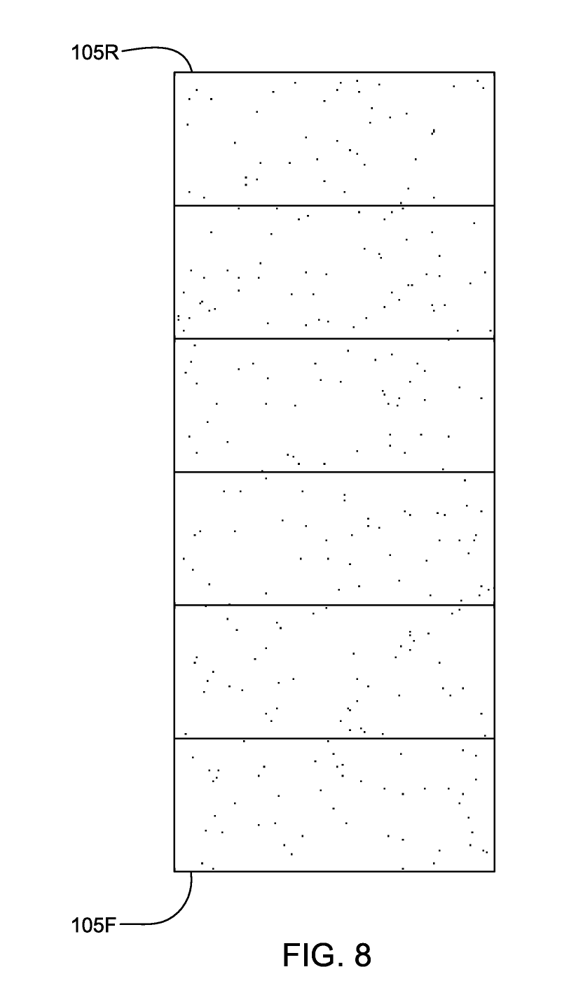

FIGS. 1-8 collectively depict an exemplary embodiment of an expandable pet tunnel and so are described herein as if they were one figure. As such, aspects of the exemplary embodiment that are referenced in this description may be evident in one or more of FIGS. 1-8. FIG. 1 is a front perspective view of an exemplary embodiment of an expandable pet tunnel according to the solution, shown in a collapsed state. FIG. 2 is a front perspective view of the exemplary embodiment of an expandable pet tunnel in FIG. 1, shown in a partially expanded state. FIG. 3 is a front perspective view of the exemplary embodiment of an expandable pet tunnel in FIG. 1, shown in a fully expanded state. FIG. 4A is a front-view of the exemplary embodiment of an expandable pet tunnel in FIG. 1, shown in a collapsed state. FIG. 4B is a front view of the exemplary embodiment of an expandable pet tunnel in FIG. 1, shown with an outer front face element folded back to expose an interior reinforcement feature. FIG. 5 is a side view of the exemplary embodiment of an expandable pet tunnel in FIG. 1, shown in a collapsed state. FIG. 6 is a top view of the exemplary embodiment of an expandable pet tunnel in FIG. 1, shown in a collapsed state. FIG. 7 is a top view of the exemplary embodiment of an expandable pet tunnel in FIG. 1, shown in a fully expanded state. FIG. 8 is a side view of the exemplary embodiment of an expandable pet tunnel in FIG. 1, shown in a fully expanded state.

Referring to FIGS. 1-8, an outer front face 105F defines a round front portal 115F. In the exemplary embodiment, the entry/exit portals 115 are depicted in a circular form, although it is envisioned that other embodiments of the solution may feature entry/exit portals defining shapes other than a circle. As such, the scope of an expandable pet tunnel is not limited by any particular shape of an entry/exit portal as different shapes for entry/exit portals will occur to those of ordinary skill in the art.

Returning to the exemplary embodiment depicted in FIGS. 1-8, interior walls 110 can be seen through front portal 115F when the embodiment is in a partially collapsed or collapsed state. Because the exemplary embodiment is designed to be expanded into a tunnel having a square cross-section along its length with front and rear entry exit portals 115 at either end, when the embodiment is collapsed the left 110L, right 110R, top 110T and bottom 110B interior walls can be partially seen through an entry/exit portal 115.

With an outer front face element 105F folded back, an interior reinforcement feature 120 is exposed (see FIG. 4B). Although all embodiments of the solution may not include an interior reinforcement feature 120, it is envisioned that certain embodiments may include an interior reinforcement feature 120 for the purpose of adding structural rigidity to the solution when in an expanded state. Further, it is envisioned that the inclusion of an interior reinforcement feature 120 may prolong the useful life of an expandable pet tunnel as the area around the entry/exit portals 115 may be susceptible to relatively more wear and tear.

It can be seen from the FIGS. 1-8 that the exemplary embodiment features a series of folds or gussets along the side walls such that the front and rear faces 105 are in close proximity when the embodiment is in a collapsed state. When the exemplary embodiment is expanded from the fully collapsed state (such as shown in FIG. 1) to the fully expanded state (such as shown in FIG. 3), outer side walls 125 are formed from the extension of the various folds and gussets. The various gussets and creases that allowed the side walls 125 to be collapsed also provide for the embodiment to be expanded such that a complete tunnel is formed with outer walls 125 and inner walls 110.

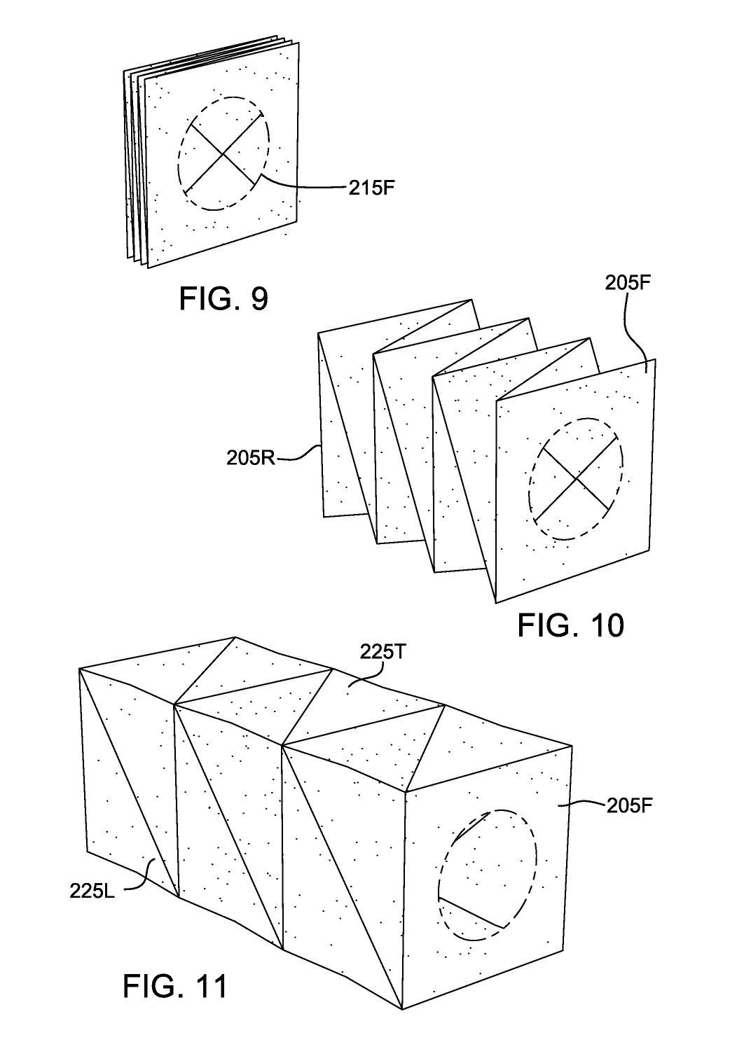

FIGS. 9-11 collectively depict an exemplary embodiment of an expandable pet tunnel and so are described herein as if they were one figure. FIG. 9 is a front perspective view of an exemplary embodiment of an expandable pet tunnel according to the solution, shown in a collapsed state. FIG. 10 is a front perspective view of the exemplary embodiment of an expandable pet tunnel in FIG. 9, shown in a partially expanded state. FIG. 11 is a front perspective view of the exemplary embodiment of an expandable pet tunnel in FIG. 9, shown in a fully expanded state.

It can be seen from the FIGS. 9-11 that the exemplary embodiment features a series of folds or gussets along the side walls such that the front and rear faces 205 are in close proximity when the embodiment is in a collapsed state. When the exemplary embodiment is expanded from the fully collapsed state (such as shown in FIG. 9) to the fully expanded state (such as shown in FIG. 11), outer side walls 225 are formed from the extension of the various folds and gussets. The various gussets and creases that allowed the side walls 225 to be collapsed also provide for the embodiment to be expanded such that a complete tunnel is formed with outer walls 225 and inner walls 210.

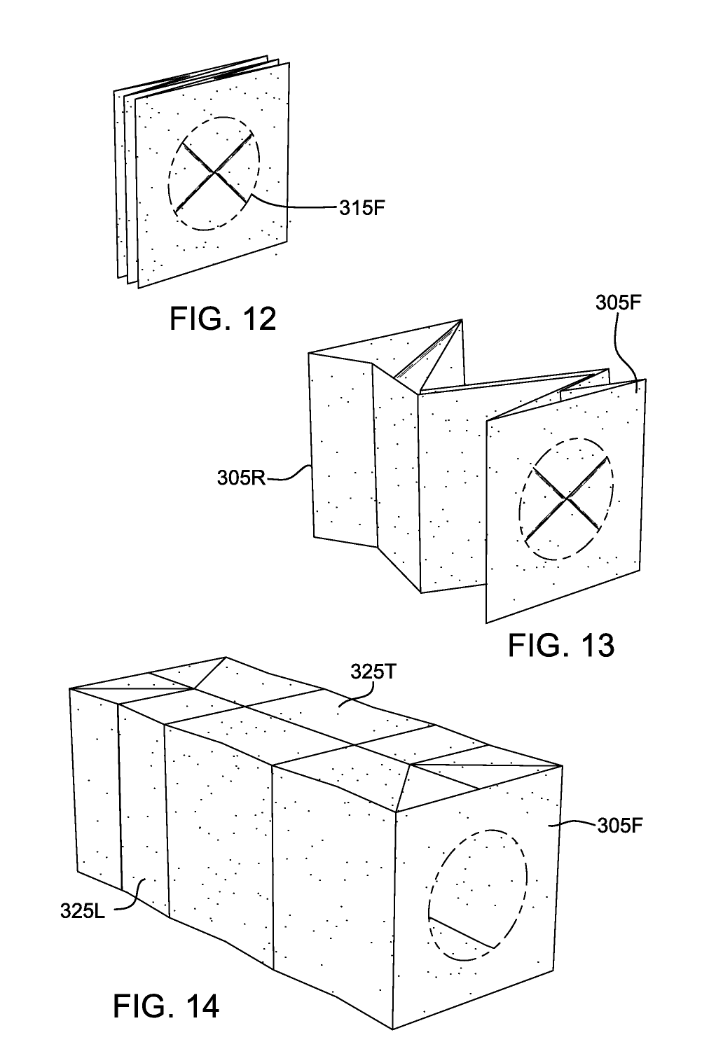

FIGS. 12-14 collectively depict an exemplary embodiment of an expandable pet tunnel and so are described herein as if they were one figure. FIG. 12 is a front perspective view of an exemplary embodiment of an expandable pet tunnel according to the solution, shown in a collapsed state. FIG. 13 is a front perspective view of the exemplary embodiment of an expandable pet tunnel in FIG. 12, shown in a partially expanded state. FIG. 14 is a front perspective view of the exemplary embodiment of an expandable pet tunnel in FIG. 12, shown in a fully expanded state.

It can be seen from the FIGS. 12-14 that the exemplary embodiment features a series of folds or gussets along the side walls such that the front and rear faces 305 are in close proximity when the embodiment is in a collapsed state. When the exemplary embodiment is expanded from the fully collapsed state (such as shown in FIG. 12) to the fully expanded state (such as shown in FIG. 14), outer side walls 325 are formed from the extension of the various folds and gussets. The various gussets and creases that allowed the side walls 325 to be collapsed also provide for the embodiment to be expanded such that a complete tunnel is formed with outer walls 325 and inner walls 310.

Exemplary embodiments of an expandable pet tunnel solution have been described using detailed descriptions of the embodiments thereof that is provided by way of example and is not intended to limit the scope of the disclosure. The described embodiments comprise different features, not all of which are required in all embodiments of an expandable pet tunnel according to the solution. Some embodiments of an expandable pet tunnel utilize only some of the features or possible combinations of the features. Variations of the exemplary embodiments of an expandable pet tunnel that are described and embodiments of an expandable pet tunnel comprising different combinations of features noted in the described embodiments will occur to persons of the art.

It will be appreciated by persons skilled in the art that an expandable pet tunnel according to the solution is not limited by what has been particularly shown and described herein above. Rather, the scope of an expandable pet tunnel is defined by the claims that follow.

What is claimed is:

1. An expandable pet tunnel, comprising:
a tube comprising four sides, a front face and a back face, wherein:
each of the front face and the back face comprises a portal; and
each of the four sides comprises one or more creases such that the expandable pet tunnel may be transitioned between a collapsed state and an expanded state.

2. The expandable pet tunnel of claim 1, wherein the four sides, front face and back face are comprised of kraft paper.

3. The expandable pet tunnel of claim 1, wherein the front face and back face further comprise a reinforcement layer.

4. The expandable pet tunnel of claim 1, wherein two of the four sides comprises a series of vertical creases.

5. The expandable pet tunnel of claim 1, wherein each of the four sides comprises a series of vertical and diagonal creases.
